(19) United States
(12) Patent Application Publication
(10) Pub. No.: US 2008/0115323 A1
(43) Pub. Date: May 22, 2008

(54) SPRING LOADED HINGE MECHANISM

(75) Inventor: Peter Karlsson, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/560,866

(22) Filed: Nov. 17, 2006

(51) Int. Cl. E05F 1/08

(52) U.S. Cl. 16/308

(57) ABSTRACT

The present invention relates to a hinge mechanism e.g. for covers with a torque element for spring loading the hinge mechanism in opened and closed positions. The hinge mechanism comprises a torque element (5) having a spring loaded mechanism with two stable end positions and including a housing (6) and a coupling member (7), wherein the torque element is arranged to provide a bearing surface (20) separately from the coupling member.

### FIELD OF THE INVENTION

The present invention relates to a hinge mechanism e.g. for covers with a torque element for spring loading the hinge mechanism in opened and closed positions. The rotation lock is provided separately of the bearing function.

### BACKGROUND OF THE INVENTION

There exist today mobile telephones of the so called clam shell type, having two halves connected by a hinge. Generally, the phone is supposed to be open when in operation. For good operability it is spring loaded, biased, in the open position to be held steadily. It is also biased in the closed position so as to not open unintentionally.

A spring loaded hinge mechanism has been developed using a torque producing rotatable element (torque element 5 in the figures). The torque element comprises a spring and cam mechanism providing stable end positions of a rotatable shaft.

In the prior art hinge mechanism the housing of the torque element was non-rotationally fitted in one half, while the protruding shaft was non-rotationally fitted in the other half. A plain bearing was fitted at the other side of the hinge. Because of the mechanical solution, the mechanism was subject to several disadvantages.

The different parts of the torque element will add up tolerances. There are tolerances between the housing of the torque element and one half, between the housing and the shaft of the torque element as well as between the shaft and the other half. At the side with the plain bearing the tolerances are just between the bearing and the halves. This led to a bigger gap at the rotation lock side. Also, the torque at the rotation lock side will push the phone half so that all the gaps will be on one side. The permanent stresses at the coupling will tend to increase the gap. Thus, the prior art hinge mechanism was unsymmetrical leading to possible misalignment problems.

To assemble the prior art hinge mechanism, the torque element was first inserted in one half. To fit the first half together with the second half, the shaft had to be pushed in, while at the same time overbending the halves relative to each other so that the shaft could snap out again in its rest position in the second half. The overbending was due to that in the end position of the hinge mechanism the shaft of the torque element is not in its end position, as there must be some rotation left to provide the spring load.

### SUMMARY OF THE INVENTION

An object of the present invention is to provide a spring loaded hinge mechanism with symmetrical and reduced tolerances. Another object of the invention is to provide a spring loaded hinge mechanism, avoiding the torque transmission in the bearing area.

Still a further object of the invention is to provide a spring loaded hinge mechanism which is easy to assemble.

In the present invention a spring loaded hinge mechanism is provided wherein the torque and bearing functions are separated.

In a first aspect the present invention provides a hinge mechanism for connecting two halves, comprising a torque element having a spring loaded mechanism with two stable end positions and including a housing and a coupling member, wherein the torque element is arranged to provide a bearing surface separately from the coupling member.

Preferably, the bearing surface is provided by the outer surface of the housing in contact with bearing holes in the two halves.

Suitably, the outer surface of the housing is substantially circular but with a flat portion providing a locking surface for securing in one of the two halves.

Suitably, the bearing surface is of metal.

In one embodiment, the coupling member is connected to a half by means of a crank arrangement external of the bearing surface.

The crank arrangement may comprise a pin arranged in an elongated locking hole spaced from the rotation axis of the hinge and centered on a line running through the rotation axis of the hinge.

Suitably, the pin is provided on a crank element and the locking hole is provided in one of the two halves.

In one embodiment, the crank element is integrated with the coupling member.

In another embodiment, the crank element is a separate element connected to the coupling member.

Suitably, the coupling member is a non-circular protruding shaft.

In a further embodiment, the coupling member is connected to a half by means of a recess provided in said half, external of the bearing surface.

Suitably, the coupling member is a protruding shaft with parallel flat sides and the recess is substantially U-shaped.

Preferably, the recess is provided in an inner shell of said half.

Preferably, the recess is provided in substantially non-yielding material, such as metal or polymethyloxylene (POM) plastic.

Suitably, the torque element is placed at one end of a hinge and a plain bearing is placed at the other end of the hinge.

The hinge mechanism may be placed between two halves of a cover for a mobile telephone, a pager, a communicator, a smart phone, or an electronic organiser.

### BRIEF DESCRIPTION OF THE DRAWINGS

Embodiments of the invention will be described in detail below with reference to the accompanying drawings, in which:

FIG. 1 is a cutaway view, partially in cross section of an assembled hinge according to a first embodiment,

FIGS. 2, 3 and 4 are a perspective view, a top view and a side view of an inner shell of a top half of a hinge mechanism according to the invention,

FIGS. 5A to 5E are plan views and perspective views of a rotation lock crank element according to one embodiment of the invention,

FIG. 6 is an exploded view of the hinge mechanism according to the first embodiment,

FIGS. 7A and 7B are a cross section view and a top view of a hinge mechanism according to another embodiment of the invention,

FIG. 8 is an exploded view of the hinge mechanism of FIGS. 7A and 7B, and

FIG. 9 is a perspective view of the hinge mechanism in a closed position.

### DETAILED DESCRIPTION OF PREFERRED EMBODIMENTS

The invention is applicable to all devices with a hinge mechanism spring loaded in opened and closed positions. Typical examples are boxes with lids and covers for electronic devices with two parts or halves. The present invention was particularly developed for an electronic device to be operable in an opened position, such as a mobile telephone, a pager, a communicator, a smart phone or an electronic organiser.

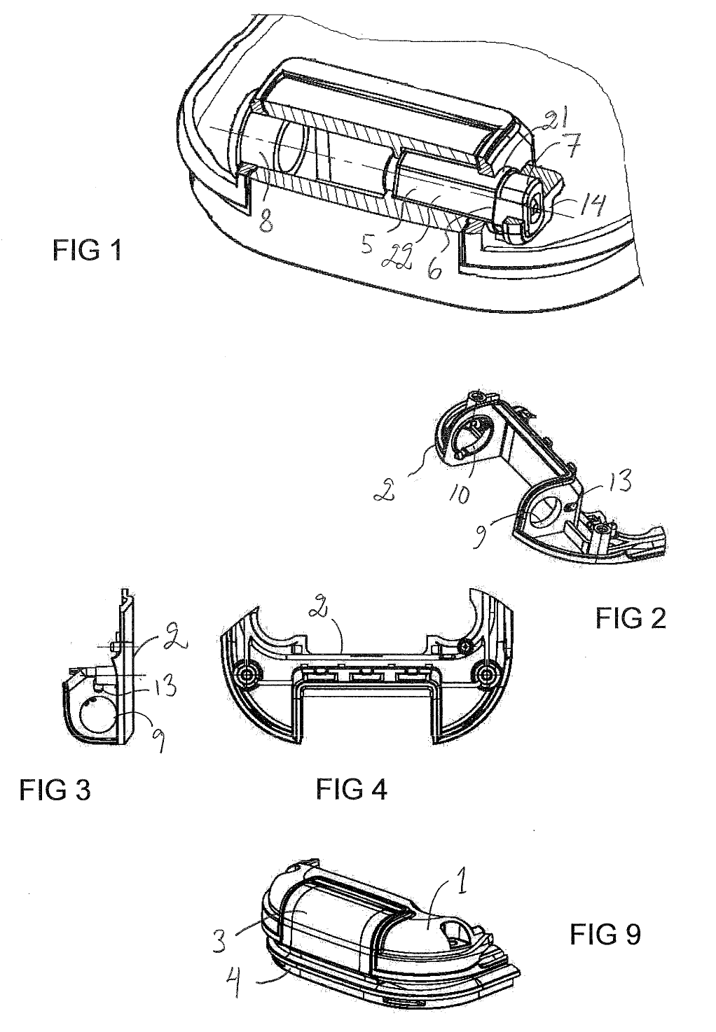

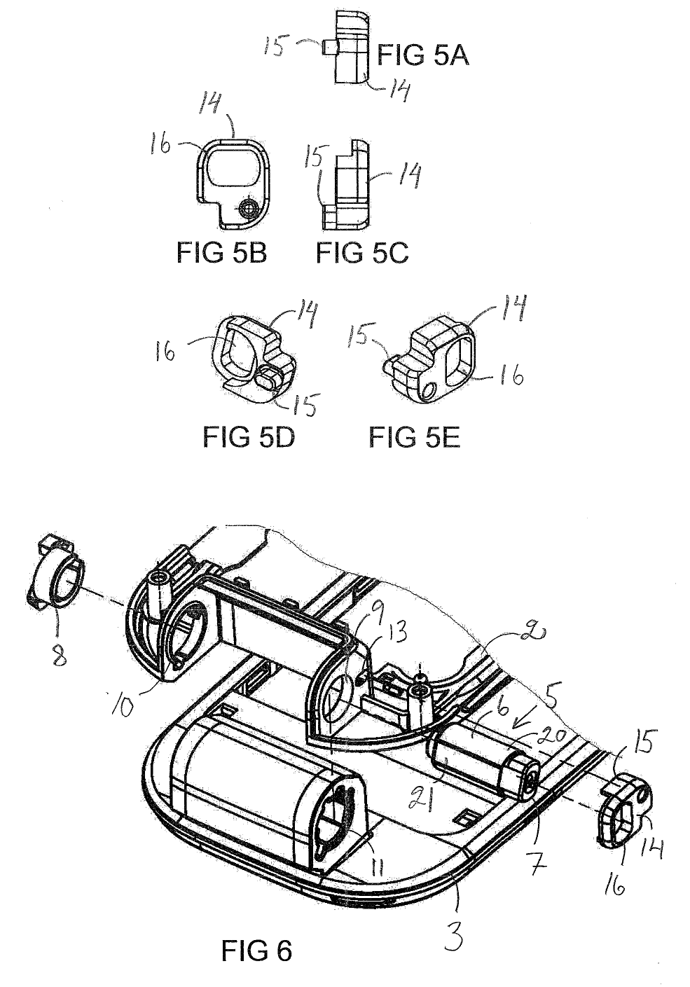

A first embodiment of the invention is shown in FIGS. 1 through 6 and 9. The hinge mechanism connects two halves of a cover for a mobile telephone. The top half comprises an outer shell 1 and an inner shell 2, and the lower half comprises an inner shell 3 and an outer shell 4. The hinge mechanism comprises a torque element 5, placed at one side. The torque element 5 comprises a housing 6 accommodating the spring loading mechanism (not shown) and a protruding shaft 7 for transmitting torque.

The spring loading mechanism can be as in the prior art as long as it has two stable end positions. In between the end positions, the mechanism forces the shaft to rotate towards the closest end position. The exact design does not form part of the invention.

At the other end of the hinge mechanism there is a plain bearing 8.

First the bearing function is described. See particularly FIG. 6. The plain bearing 8 is inserted through a hole 10 in the top inner shell 2 and a hole 12 in the lower inner shell 3. The plain bearing 8 is just snapped into place and providing a bearing surface at its circumference. No torque is transmitted at this side.

At the other side the bearing function is provided by means of the torque element 5. In contrast to the prior art, the housing 6 protrudes through both a hole 11 of the lower inner shell and a hole 9 of the top inner shell. Thus, the outer surface of the housing 6 provides a bearing surface 20. This is substantially circular so there is only small clearance between the housing 6 and the hole 9. To be able to provide torque transmission, the torque element 5 must be secured against rotation relative to one of the halves, in this case the inner shell 3 of the lower half. Thus, the circular surface 20 is interrupted by a flat surface 21 and the hole 11 is shaped correspondingly so that the torque element 5 is fixed rotationally. Other shapes are also possible. It will be appreciated that there is no torque transmitted at the bearing surfaces proper and the same tolerances and gaps are achieved at both the plain side and the torque transmission side. The housing 6 is suitably of metal or harder plastics e.g. polymethyloxylene (POM) plastic.

Next the torque function of the hinge mechanism is described. In a first embodiment, the shaft 7 of the torque element 5 is connected by means of a crank mechanism 14, 15 to the inner shell 2 of the top half. The crank element 14 carries a pin 15 fitting in a rotation lock hole 13 in the inner shell 2. Suitably, the hole 13 is oblong and placed on the centre line of the rotation axis of the hinge to prevent tolerance problems. Suitably, the pin 15 is also oblong or cylindrical. Alternatively, the crank element could be provided with a hole and the pin be provided on the inner shell (not shown).

In the first embodiment, the crank element 14 is a separate element fitted on the shaft 7. The outer surface of the shaft 7 is generally not circular, typically oblong with two flat sides as shown, and the crank element 14 is provided with a correspondingly shaped hole 16 to be rotationally secured on the shaft 7. Alternatively, the crank element could be provided with a protruding part fitting in a hole provided in torque element (not shown).

In another embodiment, the crank element 15 is integral with the shaft 7, which avoids the separate crank element 14. However, today the torque element 5 is an off the shelf item necessitating the separate crank element 14.

The assembly of the hinge mechanism may be performed as follows.

The inner shell 2 of the top half is placed on the inner shell 3 of the lower half, while aligning all the holes 9, 10, 11, 12 but without any bearings in place.

The plain bearing 8 is snapped on into the holes 10 and 12.

The torque element 5 is inserted through the holes 9 and 11 at the other side.

The crank element 14 is threaded on the shaft 7. At the same time the pin 15 is inserted in the hole 13. This requires rotation of the crank element with the shaft 7 from the rest position of the torque element 5 to the stop position between the inner shells 2 and 3. Thus, the hinge mechanism will be spring loaded in the end position between the shells 2 and 3. This rotation against the spring mechanism is necessary but quite easy to perform compared to the prior art. The rest position of the torque element 5 is usually 10 to 20 degrees beyond the stop position between the halves in the fully closed and opened positions to provide the correct spring load.

The hinge mechanism is now fully assembled and the top outer shell 1 and lower outer shell 4 may be screwed or snapped on. The final appearance is as shown in FIG. 9.

It will be appreciated that the plain bearing 8 may be assembled before the torque element 5, as described above or vice versa.

In the second embodiment the crank element 14 is integral with the shaft 7. The assembly procedure is the same as above, except that it only requires one step to insert the torque element, simultaneously rotating the crank element and inserting the rotation lock pin in the lock hole 16.

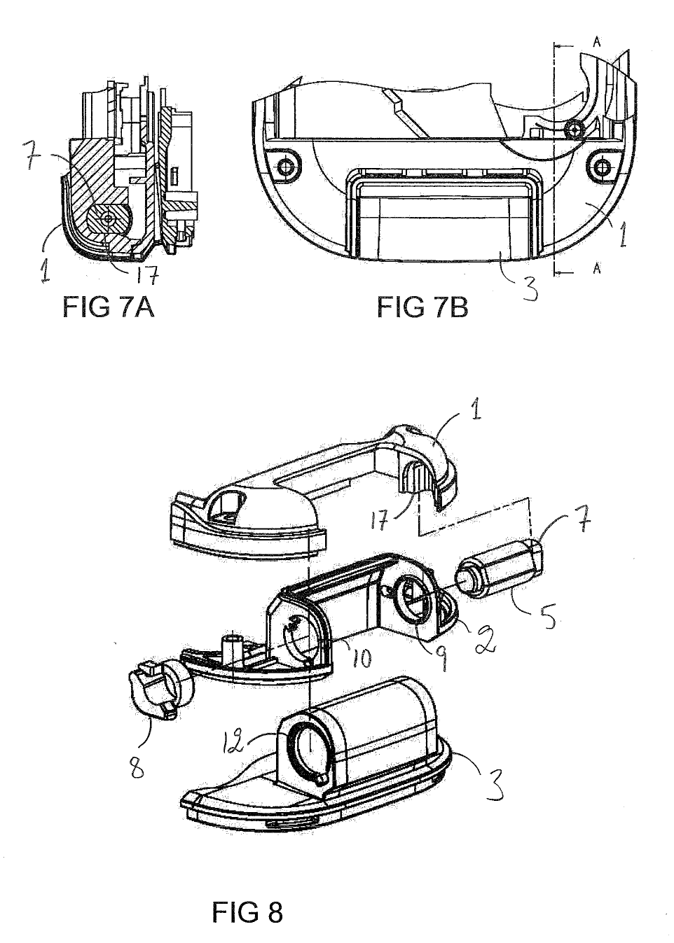

A third embodiment of the invention is described with reference to FIGS. 7 AB and 8. Identical parts are denoted by the same reference numerals. The plain bearing 8 and the torque element 5 may be identical with those of the first embodiment. In the third embodiment, the torque transmission from the torque element is achieved directly to one half without the intermediary of a crank element. A U-shaped recess 17 is arranged in the outer shell 1 of the top half. The recess 17 accommodates the protruding shaft 7.

The assembly is performed similarly to the first embodiment. The plain bearing 8 and the torque element 5 are inserted through their respective holes as before. However, for connecting the shaft 7 to the top half, the outer shell 1 is placed from the top over the shaft 7 thus aligning the shaft 7 with the recess 17. The opening of the recess 17 is suitably flared, so that the shaft 7 automatically is aligned when pressing down the outer shell 1.

In a mobile telephone the cover is usually made of plastics, i.e. a yieldable material not suitable for resisting permanent stresses. Thus, the recess 17 is preferably made of a harder material, such as metal or harder plastics e.g. polymethyloxylene (POM) plastic. The whole outer shell 1 may be made from this material.

The invention has been described by means of preferred embodiments set forth in detail. However, the embodiments should be considered as examples and the scope of the invention is only limited by the claims below.

1. A hinge mechanism for connecting two halves, comprising a torque element having a spring loaded mechanism with two stable end positions and including a housing and a coupling member, wherein the torque element is arranged to provide a bearing surface separately from the coupling member.

2. A hinge mechanism according to claim 1, wherein the bearing surface is provided by the outer surface of the housing in contact with bearing holes in the two halves.

3. A hinge mechanism according to claim 2, wherein the outer surface of the housing is substantially circular but with a flat portion providing a locking surface for securing in one of the two halves.

4. A hinge mechanism according to claim 2, wherein the bearing surface is of metal.

5. A hinge mechanism according to claim 1, wherein the coupling member is connected to a half by means of a crank arrangement external of the bearing surface.

6. A hinge mechanism according to claim 5, wherein the crank arrangement comprises a pin arranged in an elongated locking hole spaced from the rotation axis of the hinge and centered on a line running through the rotation axis of the hinge.

7. A hinge mechanism according to claim 6, wherein the pin is provided on a crank element and the locking hole is provided in one of the two halves.

8. A hinge mechanism according to claim 7, wherein the crank element is integrated with the coupling member.

9. A hinge mechanism according to claim 7, wherein the crank element is a separate element connected to the coupling member.

10. A hinge mechanism according to claim 9, wherein the coupling member is a non-circular protruding shaft.

11. A hinge mechanism according to claim 1, wherein the coupling member is connected to a half by means of a recess provided in said half, external of the bearing surface.

12. A hinge mechanism according to claim 11, wherein the coupling member is a protruding shaft with parallel flat sides and the recess is substantially U-shaped.

13. A hinge mechanism according to claim 11, wherein the recess is provided in an inner shell of said half.

14. A hinge mechanism according to claim 11, wherein the recess is provided in substantially non-yielding material, such as metal or polymethyloxylene (POM) plastic.

15. A hinge mechanism according to claim 1, wherein the torque element is placed at one end of a hinge and a plain bearing is placed at the other end of the hinge.

16. A hinge mechanism according to claim 1, wherein the hinge mechanism is placed between two halves of a cover for a mobile telephone, a pager, a communicator, a smart phone, or an electronic organiser.
